(19) United States
(12) Patent Application Publication
(10) Pub. No.: US 2025/0337262 A1
(43) Pub. Date: Oct. 30, 2025

(54) STAND-ALONE MULTI-FUNCTION BATTERY MANAGER

(71) Applicant: Caterpillar Inc., Peoria, IL (US)

(72) Inventors: Andrew J. PEPLINSKI, Peoria, IL (US); Yangyang FANG, Jiangsu (CN); Swati NARULA, Bengaluru (IN); Kurt D. PRZYBYLA, Wolcottville, IN (US)

(73) Assignee: Caterpillar Inc., Peoria, IL (US)

(21) Appl. No.: 18/644,637

(22) Filed: Apr. 24, 2024

(51) Int. Cl. H02J 7/00

(52) U.S. Cl. CPC H02J 7/00712; H02J 7/00036; H02J 7/0048; H02J 7/0014

(57) ABSTRACT

A mobile battery manager for charging or discharging a stored battery system may include a converter, a resistive load, and a controller configured to charge or discharge the stored battery system to a desired state of charge determined at the mobile battery manager.

### TECHNICAL FIELD

The present disclosure relates generally to systems and methods for a battery manager, and more particularly, to systems and methods for a battery manager that charges, discharges, and/or balances high voltage battery systems.

### BACKGROUND

Batteries from battery powered heavy machinery often require that a specific state of charge (SoC) be achieved for multiple reasons. For example, high voltage batteries may require discharging in order to reach a specific SoC required by transportation regulations in instances when high voltage batteries are being transported overseas. A different SoC may be required when transporting high voltage batteries as cargo on land. In another example, charging a high voltage battery to a desired level may be preferred before the battery is placed in use, so as to provide sufficient power for a specific job. In addition, monitoring and controlling individual battery cell balancing may be useful to ensure a battery's longevity. Failure to consider a battery's state of charge during storage or transportation may increase the risk of a potentially hazardous condition or result in noncompliance with battery storage or transportation regulations. Further, the failure to consider SoC in preparation for use of a high volt battery may result in unnecessary battery replacements or waiting for a battery to charge, both of which may result in avoidable expenses due to idle delays. Thus, in order to help preserve the lifespan of a high voltage battery, comply with battery transportation or storage regulations, or prepare a high voltage battery for use, there exists a need for an all-in-one stand-alone battery managing system.

An exemplary method for maintaining charge control of a battery array is described in U.S. patent application Publication Ser. No. 17/081,296, published on Apr. 29, 2021 (“the '296 patent”). The method described in the '296 patent may include controlling a battery charge current and voltage using a Pulse Width Modulation (PWM) signal or an inductor to either establish a restricted battery charge current or battery voltage. While the method described in the '296 patent may be helpful for managing batteries, it might not be able to serve as an all-in-one stand-alone battery managing system.

The disclosed method and system of the present disclosure may solve one or more of the problems set forth above and/or other problems in the art. The scope of the current disclosure, however, is defined by the attached claims, and not by the ability to solve any specific problem.

### SUMMARY

In one aspect, a mobile battery manager for charging or discharging a stored battery system may include a converter, a resistive load, and a controller configured to charge or discharge the stored battery system to a desired state of charge determined at the mobile battery manager.

In another aspect, a stored battery management method for a stored battery system may include communicating with the stored battery system to receive stored battery system data; determining, from the stored battery system data, a battery system profile; and charging or discharging the stored battery system with a battery manager, the charging or discharging based on the battery system profile and a desired state of charge received at the battery manager.

In yet another aspect, a stored battery management method for a stored battery system may include communicating with the stored battery system to receive stored battery system data; determining, from the stored battery system data, a battery system profile; determining whether to charge or discharge the stored battery system and a corresponding charge or discharge rate based on the battery system profile; and charging or discharging the stored battery system at the corresponding charge or discharge rate.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 is a diagram illustrating an exemplary environment of a battery manager, according to aspects of the disclosure.

FIG. 2 illustrates a diagram of an exemplary controller system of the battery manager of FIG. 1.

FIG. 3 provides a flowchart depicting an exemplary method for the battery manager of FIG. 1.

### DETAILED DESCRIPTION

Both the foregoing general description and the following detailed description are exemplary and explanatory only and are not restrictive of the features, as claimed. As used herein, the terms “comprises,” “comprising,” “has,” “having,” “includes,” “including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, unless stated otherwise, relative terms, such as, for example, “about,” “substantially,” and “approximately” are used to indicate a possible variation of +10% in the stated value.

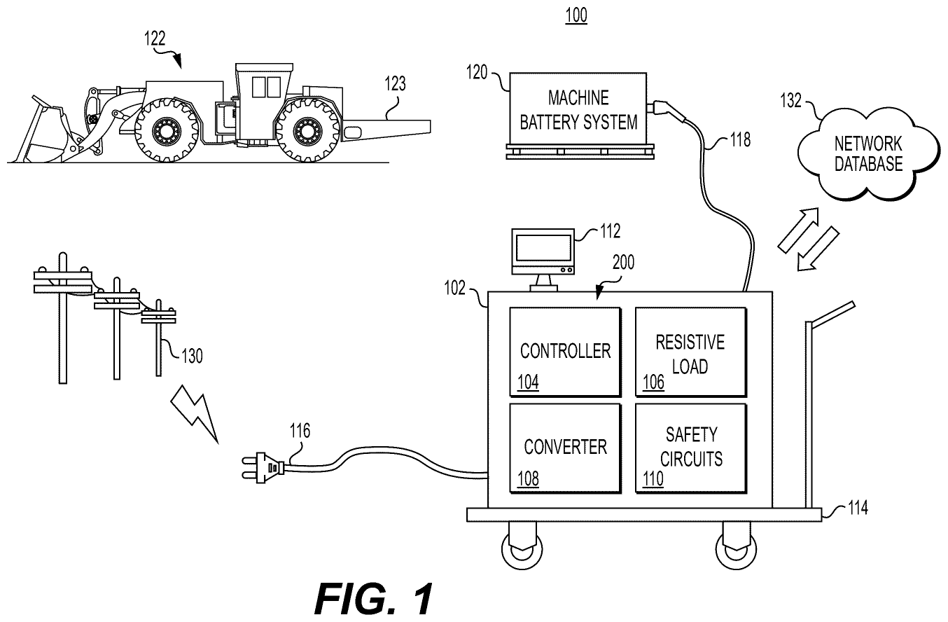

FIG. 1 is a diagram illustrating an exemplary environment 100 of battery manager 102, according to aspects of the disclosure. Environment 100 may include an electric powered mobile industrial machine 122, a selectively removable machine battery system 120 for powering machine 122, and a battery manager 102 for charging, discharging and otherwise managing one or more machine battery systems 120. Battery manager 102 may receive power from power source 130, and exchange data with a remote network database 132.

FIG. 1 depicts machine 122 as an electrically powered load-haul-dump (LHD) type mining machine, however, other types of machines are contemplated, such as, for example, hauling machines, articulated/dump trucks, backhoe loaders, mining shovels, cold planers, dozers, skid steer loaders, motor graders, etc. Machine 122 may include a battery support portion 123 configured to receiving and electrically couple with the machine battery system 120 for providing power to an electric drive system of machine 122 having one or more electric drive motors. Machine 122 may be an all-electric machine 122 fully powered by the machine battery system 120, or may be partially powered by the machine battery system 120, such as a hybrid-type drive additionally including an engine.

Machine battery system 120 may be a high voltage battery pack including, for example, a plurality of modules including a plurality of cells, and one or more battery management systems having associated sensors. When not coupled to machine 122, as shown in FIG. 1, machine battery system 120 may be in storage, such as in a warehouse awaiting use on machine 122. Alternatively, machine battery system 120 may be in transport as freight or cargo. In either instance, machine battery system 120 is disconnected from machine 122 and not in active use.

In an exemplary embodiment, after being used on machine 122, machine battery system 120 may be swapped out for a freshly charged battery and dropped off for temporary storage. Machine battery system 120 may be stored for a period of time, may require preparation for next use, or may require preparation for transport. Additionally, machine battery system 120 may require a status update or safety protocol to determine its health and fitness.

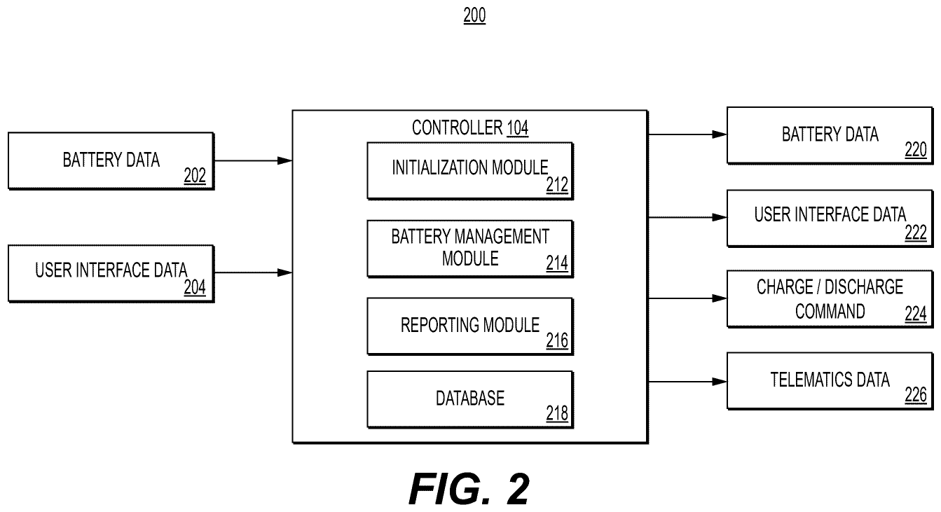

Battery manager 102 may include different components to perform different protocols on machine battery system 120. Machine battery system 120 may connect to battery manager 102 via connection terminal 118. Connection terminal 118 may include any known types of high voltage electrical connectors, such as a standard J1772 connector (J plug or Type 1). In certain embodiments, battery manager 102 may require power and may include a power connection 116 connected to a power source 130. While the exemplary environment 100 depicts power source 130 as an AC power grid, other forms of power may be sourced, such as an AC-DC generator, batteries, etc. Upon connection via connection terminal 118, battery manager 102 may utilize a battery controller system 200 including battery controller 104 to perform different protocols on machine battery system 120. As will be discussed in greater detail in FIG. 2, battery controller 104 may receive input information from user interface 112 and process the information using processors and/or memory devices to determine various outputs or protocols to perform in relation to machine battery system 120. User interface 112 may be simple in nature and display. For example, user interface 112 may merely receive, as entered by a user, a desired SoC and/or storage or transportation information, and battery manager 102 will determine and perform all the necessary steps and/or procedures without any additional monitoring by the user. If battery manager 102 is in the middle of operation, a user may simply view the user interface to observe a snapshot of the battery system, e.g. current SoC, temperature, safety checks, use and maintenance logs, etc.

In one exemplary embodiment, battery controller 104 may utilize safety circuits 110 to perform a safety check protocol on machine battery system 120. Safety circuits 110 may include a multimeter, calorimeter, a battery impedance tester, or other known methods and equipment to determine a status of machine battery system 120, both as an overall battery systems array and as individual battery cells of the overall array.

Battery controller 104 may utilize a resistive load 106 to discharge machine battery system 120 to a desired state of charge (SoC). Resistive load 106 may include, for example, a variety of different sized resistors in order to add different sized loads to machine battery system 120, such that stored energy of machine battery system 120 may be dissipated to a desired SoC at a desired rate and/or in a desired amount of time. Battery controller 104 may determine the desired SoC, for example, based on information received at user interface 112, and adjust resistive load 106 accordingly.

Battery controller 104 of battery manager 102 may also determine that machine battery system 120 is to be charged. Battery controller 104 may utilize converter 108 to convert energy from power source 130 to machine battery system 120. Converter 108 may include, for example, a rectifier including one or more of switches, inductors, transformers, capacitors and diodes. In one exemplary embodiment, battery controller 104 may direct power from power source 130 to charge machine battery system 120 to a desired SoC, at a specific rate of charge, or in a specific amount of time.

In an exemplary embodiment, battery manager 102 may be installed as part of a mobile system 114 so as to be easily navigable to different machine battery systems 120. In one exemplary embodiment, mobile system 114 may include a manual cart that allows battery manager 102 to be rolled easily on flat surfaces. In addition, battery manager 102 may include a transmission device that allows for transmission of information and data related to machine battery system 120 and battery manager 102 to network database 132. The transmission device could include, for example, a wired or wireless transmission device including, for example, one or more antenna, transmitters, and receivers, etc.

FIG. 2 is a diagram of battery controller system 200 of the battery manager 102. As noted above, battery controller system 200 may include battery controller 104 receiving inputs such as battery data 202 and user interface data 204. Battery controller 104 processes the input information via an initialization module 212, a battery management module 214, and/or a reporting module 216. Battery controller 104 may provide one or more outputs such as battery data 220, user interface data 222, a charge/discharge command 224, and telematics data 226, each of which will be discussed below.

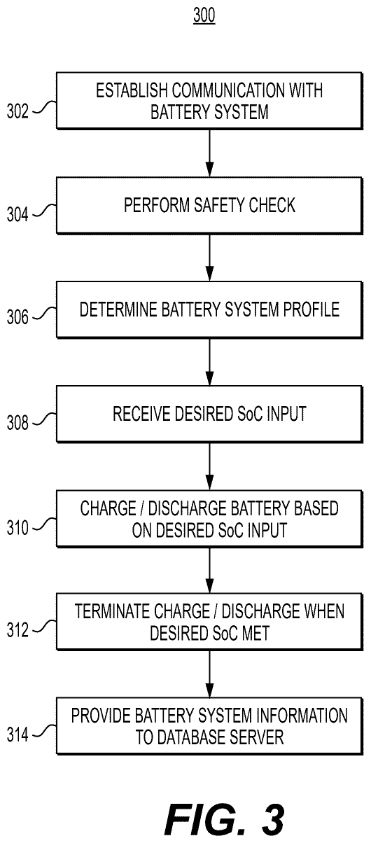

Battery controller 104 may embody a single microprocessor (CPU) or multiple microprocessors, a memory, a database 218 or secondary storage device, and/or any other means for accomplishing a task consistent with the present disclosure. The memory or database 218 associated with battery controller 104 may store data and/or software routines that may assist battery controller 104 in performing its functions, such as the functions of method 300 of FIG. 3. In addition, the memory or database 218 associated with battery controller 104 may store data received from the various inputs associated with battery controller system 200. Further, memory or database 218 may include SoC regulations for transporting or storing, for example, as a function of location and/or a shipping process. Numerous commercially available microprocessors can be configured to perform the functions of battery controller 104. Battery controller 104 may embody a non-transitory machine-readable medium that stores information that, when executed by battery controller 104, causes the battery controller system 200 to perform instructions and may be computer-implemented. It should be appreciated that battery controller 104 could readily embody a general machine controller capable of controlling numerous other machine functions. Alternatively, a special-purpose machine controller could be provided. Further, one or more operations of battery controller 104, may be performed remote over a network through network database 132 and communicated to battery manager 102. Various other known circuits may be associated with battery controller 104, including signal-conditioning circuitry, communication circuitry, actuation circuitry, and other appropriate circuitry.

As noted above, inputs of controller 210 may include battery data 202 and user interface data 204. Battery data 202 may be provided upon using connection terminal 118 to connect machine battery system 120 to battery manager 102. Battery data 202 may include stored battery system data such as a battery profile and charge information such as battery type, SoC, voltage, physical size, manufacturing date, etc. Battery data 202 may also include usage data such as machine 122 compatibility, dates, times, and locations of usage, ownership, assigned projects, next in-use date, etc. User interface data 204 may include information provided by a user via user interface 112. User interface data 204 may include receiving input such as a desired state of charge, time to charge, time to discharge, or an indication to perform a safety check.

After connection of battery manager 102 with battery machine system 120 via connection terminal 118, battery controller 104 may proceed with an initialization via initialization module 212. This module may be performed upon receiving battery data 202 that includes information that an initial “handshake” connection between battery manager 102 and machine battery system 120 has been made. Using safety circuits 110, battery controller 104 may analyze machine battery system 120 to test fluid levels, temperature, or operability. Safety circuits 110 may also test machine battery system 120 for connectivity, proper grounding, or any leakage. Battery controller 104 may also perform a battery load test as part of the initialization module to determine initial battery parameters. Other tests may be performed to determine an overall safety compliance of the complete battery system or tests may be performed to determine the health and functionality of each individual battery cell of machine battery system 120.

In addition, battery controller 104 may perform battery management via battery management module 214. Battery management module 214 may include charging or discharging machine battery system 120, depending on the inputs of battery data 202 and user interface data 204. In an exemplary embodiment, battery management module 214 may determine a desired state of charge and how to achieve the desired state of charge. For example, battery controller 104 may determine that machine battery system 120 needs to be charged in instances where the current state of charge is lower than the desired charge. Alternatively, battery controller 104 may determine that machine battery system needs to be discharged in instances where the current state of charge is higher than the desired charge. Battery management module 214 may consider other parameters such as time to charge or discharge, rate at which to charge or discharge, total duration of charging or discharging, etc.

Battery controller 104 may also perform a reporting via a reporting module 216. Reporting module 216 may include preparing a report that includes information of machine battery system 120 including any of the information noted above, such as battery data 220 including profile information and/or battery charge information, safety check information, and/or charging or discharging activity. The information prepared by reporting module 216 may be stored in a database 218, and/or may be sent to remote network database 132 for access over various platforms.

As outputs, battery controller 104 may provide battery data 220 that includes information and parameters such as the battery data 202 mentioned above as an input to controller 104. For example, input battery data 202 may include data related to what is needed to manage machine battery system 120 and output battery data 220 may include data or information that confirms or relates to machine battery system 120 operating properly and efficiently. In one exemplary embodiment, machine battery system 120 may export battery data 202 to battery manager 102 and then sent as battery data 220 to network database 132. In another embodiment, battery data 220 may be exported as a printable paper report to be printed or saved by an attached computer. In another exemplary embodiment, battery data 220 may be provided and continually updated to user interface 112 so that users may be able to view user interface 112 and determine the current charging or discharging status of machine battery system 120. User interface data 204 may include a status, such as “initializing”, “charging”, “discharging”, “paused”, or “complete” along with any of the other data discussed above.

As previously discussed, battery controller 104 may output a charge/discharge command 224 to enable battery manager 102 to supply charge to, or discharge charge from, maching battery system 120. The charge/discharge command 224 may also include a rate at which to charge/discharge, a duration of charge/discharge, based on a desired SoC. In addition, a charge/discharge command 224 may include a stop command upon the SoC goal being achieved. In another exemplary embodiment, a charge/discharge command 224 may include a maintain SoC command where a small trickle charge is provided to offset any small battery power leakage or discharge.

Outputs may also include telematics data 226 wherein battery manager 102 may transmit battery data, e.g., via a wireless networks, to a remote server, such as remote network database 132 for storage, processing, tracking, and access over a network.

FIG. 3 provides a flowchart of method 300 depicting an exemplary method for battery manager 102. In an exemplary embodiment, the process may perform step 302 and establish communication by using connection terminal 118 to physically connect machine battery system 120 with battery manager 102. Upon establishing communication, initialization module 212 may confirm a data connection or “handshake” between the systems and perform a safety check (step 304) on machine battery system 120. The safety check may include checking fluid levels, monitoring temperature, verifying connectivity and proper grounding, or determine the overall safety of machine battery system 120. Other tests may be performed to determine an overall safety compliance of the machine battery system 120. Additionally, safety tests may be performed to determine the health and functionality of each individual battery cell of machine battery system 120, including performing battery cell balancing as needed.

Method 300 may then perform step 306 and determine a battery system profile based on battery data 202 and user interface data 204. An example of a battery system profile may include the characteristics of the battery including type, size, SoC, machine compatibility, etc. A battery system profile may further include a storage profile including where machine battery system 120 may be stored for a period of time. A storage profile may be further broken down into long term storage or short term storage depending the period of time machine battery system is set or intended to be stored. Another example of a battery profile system may include a transport profile for batteries that are to be transported. The transport profile may be further defined by the type of carrier, such as by a ship, barge, train, truck or plane. Alternatively, the transport profile may be further defined by an initial location of origin or the final destination. In another embodiment, the travel profile may include a location of the job site. A battery system profile may include other profiles as determined by a user entering the profile through user interface 112 and/or received from the machine battery system 120, received via network database 132, or received via database 218. For example, a remote server associated with network database 132 may include a catalogue of machine battery systems and may change, update, or provide battery system profiles on battery manager 102.

In the exemplary embodiment, method 300 may include step 308 of receiving a desired SoC input. The SoC input may be received, via user interface 112 as user interface data 204 to be added to the battery system profile and/or may be received via a remote server associated with network database 132, or may be retrieved from database 218 that associates a desired SoC based on other battery system profile data. An SoC input may include a time component, such as when maintaining an SoC for a particular period of time. A state of charge may also include a voltage requirement. For example, a desired SoC may be 1000 volts. Alternatively, a SoC may be a percentage, such as 30%, where 0% is completely discharged and 100% is fully charged. An SoC may also have a time component, such as when maintaining an SoC of machine battery system 120 for a particular period of time. In another exemplary embodiment, a desired SoC may be associated with a regulation for storing or transporting machine battery system 120. Rather than receiving an SoC input, a user may input profile information, such as a storage location or a transportation process, via user interface 112. Database 218 may then be accessed and based on the input profile information, determine the desired SoC.

Step 310 may include charging or discharging machine battery system 120 based on the desired SoC input. Charging or discharging may be performed at a charge or discharge rate determined by battery management module 214. For example, an immediate need for machine battery system 120 may arise and battery management module 214 may charge machine battery system 120 at the highest charge rate possible until it is fully charged. Alternatively, battery manager 102, through battery management module 214 may determine that machine battery system 120 is to be reduced to a 50% SoC so that it will comply with transport regulations when it is shipped out in two days. In this example, battery controller 104 may discharge a machine battery system 120 at a rate such that machine battery system 120 will finish discharging in two days. In this example, it may be beneficial to end discharging on the day of transportation because if discharging were to be completed earlier, machine battery system 120 may lose additional charge, such as through self-discharging, and thus not correspond with the desired shipping SoC.

Method 300 includes step 312, terminating the charge or discharge when the desired SoC is met. In continuation of the example above, discharging may be terminated when machine battery system 120 reaches a SoC of 50%. In another example, charging machine battery system 120 may be terminated when machine battery system 120 has reached a rated maximum SoC of the machine battery system 120 and is considered fully charged.

Lastly, in this exemplary embodiment, method 300 may include providing battery system information to a network database 132, or cloud based server, in the form of telematics data 226. System information may include duration of charge, final SoC, time charging or discharging was completed, or other relevant charging parameters.

### INDUSTRIAL APPLICABILITY

The disclosed method has applicability in industry by providing a system for effectively managing a machine battery system 120. For example, the disclosed battery manager 102 may monitor and manage a machine battery system 120 that is disconnect from its associated industrial machine 122, and requires a particular charge or discharge to establish a desired SoC. The desired SoC may be required for various reasons, such as to comply with storage and/or transportation regulations for battery systems.

The above described battery manager 102 and associated method provides an all-in-one stand-alone system for managing a machine battery system 120. Managing high voltage batteries may include charging or discharging a machine battery system 120 to a set SoC. The SoC may be easily provided by a user through a simple user interface. Alternatively, a user may provide other information, such as a location if machine battery system 120 is being stored, or a route if machine battery system 120 is being transported. Database 218 may be accessed to determine any applicable government regulations to consider when determining the SoC for the machine battery system 120. Thus, management of machine battery system 120 requires minimal input and oversight. In addition, the mobility of battery manager 102 allows for battery manager 102 to be easily moved in order to manage multiple machine battery systems at various locations. Also, battery manager 102 may perform a safety check to ensure the fitness and health of machine battery system 120 is appropriate.

It will be apparent to those skilled in the art that various modifications and variations can be made to the disclosed system without departing from the scope of the disclosure. Other embodiments of the system will be apparent to those skilled in the art from consideration of the specification and practice of the system disclosed herein. It is intended that the specification and examples be considered as exemplary only, with a true scope of the disclosure being indicated by the following claims and their equivalents.

What is claimed is:

1. A mobile battery manager for charging or discharging a stored battery system, comprising:
a converter;
a resistive load; and
a controller configured to charge or discharge the stored battery system to a desired state of charge determined at the mobile battery manager.

2. The mobile battery manager of claim 1, wherein the controller is further configured to determine a profile of the stored battery system.

3. The mobile battery manager of claim 2, wherein the profile includes a battery system type, and
the battery system type is received from the stored battery system.

4. The mobile battery manager of claim 2, wherein the profile includes storage location information or transportation information.

5. The mobile battery manager of claim 2, wherein the controller determines the desired state of charge based on the determined profile of the stored battery system.

6. The mobile battery manager of claim 1, wherein the controller stops charging or discharging when the stored battery system achieves the desired state of charge.

7. The mobile battery manager of claim 1, wherein the controller is further configured to initiate communication with the stored battery system.

8. The mobile battery manager of claim 1, wherein the controller is further configured to initiate a safety check of the stored battery system after initiating communication.

9. The mobile battery manager of claim 1, wherein the controller is further configured to transmit battery data to a network database.

10. A stored battery management method for a stored battery system, the method comprising:
communicating with the stored battery system to receive stored battery system data;
determining, from the stored battery system data, a battery system profile; and
charging or discharging the stored battery system with a battery manager, the charging or discharging based on the battery system profile and a desired state of charge received at the battery manager.

11. The stored battery management method of claim 10, wherein the desired state of charge is received via a user interface.

12. The stored battery management method of claim 10, wherein communicating with the stored battery system further comprises performing a safety check.

13. The stored battery management method of claim 12, wherein performing the safety check further comprises performing battery cell balancing.

14. The stored battery management method of claim 10, wherein the battery system profile includes a storage location information or transportation information.

15. A stored battery management method for a stored battery system, the method comprising:
communicating with the stored battery system to receive stored battery system data;
determining, from the stored battery system data, a battery system profile;
determining whether to charge or discharge the stored battery system and a corresponding charge or discharge rate based on the battery system profile; and
charging or discharging the stored battery system at the corresponding charge or discharge rate.

16. The stored battery management method of claim 15, wherein the corresponding charge or discharge rate is based on a received completion time.

17. The stored battery management method of claim 15, wherein charging or discharging the stored battery system is terminated based on the stored battery system achieving a desired state of charge.

18. The stored battery management method of claim 15, wherein receiving stored battery system data is received from a network database.

19. The stored battery management method of claim 15, further comprising:
performing a safety check of the stored battery system.

20. The stored battery management method of claim 15, wherein charging or discharging the stored battery system is based on a state of charge associated with the battery system profile.
